(19) United States
(12) Patent Application Publication
(10) Pub. No.: US 2009/0316667 A1
(43) Pub. Date: Dec. 24, 2009

(54) GSM HARMONIC EMISSION DESENSITIZATION IN 5-GHZ WLAN

(75) Inventors: Olaf Hirsch, Sunnyvale, CA (US); Steve Shearer, Pleasanton, CA (US); Charles Razzell, Pleasanton, CA (US)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/097,612

(22) PCT Filed: Dec. 14, 2006
(86) PCT No.: PCT/IB2006/054831

§ 371 Date: Feb. 20, 2009

Related U.S. Application Data
(60) Provisional application No. 60/751,133, filed on Dec. 16, 2005.

(51) Int. Cl. H04W 4/00

(52) U.S. Cl. 370/338

(57) ABSTRACT

A method for improving data communication quality in collocated GSM and WLAN subsystems. The GSM device can spuriously emit third harmonics whose frequencies depends on which GSM channel is presently being used. The WLAN receiver uses OFDM subcarriers that can be interfered with by third harmonics of particular ones of the GSM channels. Which OFDM subcarriers would be adversely affected by a particular one of the GSM channels being in use is computed. Then a corresponding particular OFDM subcarrier is deleted after a FFT process and before Viterbi decoding.

The present invention relates to dual-mode GSM WLAN phones that use the IEEE-802.11a mode, and more particularly to inexpensive methods and equipment to reduce co-interference on the 5-GHz band.

Multimode portable electronic devices are now starting to appear that were never contemplated by the standards bodies that gave birth to their constituent parts. These combinations are very useful, but the wireless modes they use can cause mutual interference. For example, incorporating a global positioning system (GPS) in a mobile telephone allows 911 emergency calls to include the user's position, and the GPS clocks can provide extraordinarily accurate time and frequency standards. Voice over Internet protocol (VoIP) can be combined with wireless local area network (WLAN) to provide telephone service, and global system for mobile communications (GSM) mobile phones can support wide-area wireless Internet access for notebook computers.

Multimode GSM mobile phones are now able to dynamically support telephone connections via VoIP and WLAN connections to save money and/or to improve connection quality. IEEE-802.11b/g type WLAN's use the 2.4-GHz unlicensed radio spectrum, while IEEE-802.11a type WLAN's use the twenty-three orthogonal frequency division multiplexing (OFDM) channels in the 5-GHz band set aside for them. Bluetooth communications can interfere with the 802.11b/g WLAN's using the 2.4-GHz band, and the third harmonics of some GSM channels can interfere with particular OFDM sub-carrier frequencies in the 5-GHz IEEE-802.11a WLAN channels.

Isolation and shielding between collocated radios is an effective way to reduce co-interference. But, the small form factors and finite isolation effects afforded by antenna orientation and layout limit how practical such isolation and shielding can be. Better filtering on the transmitter outputs helps a lot, but such also increases device size and cost. Extra filtering can unfortunately reduce transmitter efficiency and linearity. Cross-modulation components can be reduced by increasing the transmitter linearity, but at the cost of efficiency. However, battery powered portable devices have to be very efficient in their use of power.

At least two kinds of this interference are possible in a simple device that combines only a GSM mobile phone and a IEEE-802.11a WLAN. The WLAN transmitter can interfere with the GSM receiver, and the GSM transmitter can interference with the WLAN's receiver. In particular, third harmonics, or spurs, of the GSM transmissions fall within the UNII bands and can corrupt individual ones of the OFDM sub-carriers received by the WLAN. When the WLAN transmitter is operating, its output signals can swamp and desensitize the GSM receiver by raising the broadband noise floor.

In order to deal with interference, several multi-mode devices try reducing the output power levels for both the GSM and WLAN radios. But these measures can increase the cost and the size, and reduce the range. Increased front-end filtering improves selectivity at a cost, and increasing the physical separation between the WLAN and GSM antennas reduces coupling and makes the device larger.

Some conventional multi-mode GSM/WLAN systems have resorted to non-simultaneous operation. The WLAN transmitter is turned off whenever the GSM radio is active, thus preventing any degradation to GSM. Whenever a GSM transmission interferes with the reception of a WLAN transmission, the WLAN subsystem has to depend on the WLAN access point to automatically retransmit the packet. What results is a need for some type of traffic management, or scheduling within the multi-mode solution. This scheduling is often implemented within the application software or top-level baseband protocol stacks. The result is a functional multi-mode solution, but only one mode is active at any one time. One chip maker has developed multi-mode intellectual property (IP) that implements the needed scheduling. GSM transmissions and receptions are synchronized with those of the collocated WLAN. A single radio chain can be used for a multi-mode solution. This allows for a simple architecture, and it reduces the overall time-averaged power consumption of the multi-mode handset.

To avoid desensitizing the GSM receiver, the IP schedules WLAN transmission for periods when GSM will not need the radio channel. The scheduling algorithms synchronize their access point transmissions to GSM radio activity. Such technology just about eliminates the interference between WLAN and GSM subsystems.

In multi-mode implementations, the probability of a successful WLAN transaction is proportional to the length of the WLAN packet. As the WLAN packets increase in length, they are more likely to overlap with a competing GSM burst. The WLAN packet will be dropped, requiring it to be retransmitted at a later time. WLAN downlinks tend to be more robust as the WLAN receiver can operate during both GSM idle times and receive bursts.

In February 2004, the Federal Communications Commission (FCC) issued a revision to the regulations for the unlicensed national information infrastructure (UNII) bands and 5-GHz channel usage. Such revision added eleven channels, for a total of twenty-three. But, in order to use the eleven new channels, radios must incorporate two new features. These are part of the IEEE-802.11h standard, e.g., transmitter power control (TPC) and dynamic frequency selection (DFS).

IEEE-802.11a performs better since it runs in 5-GHz spectrum and therefore is less susceptible to interference, latency and packet dropping problems that arise in the overcrowded 2.4-GHz band used by IEEE-802.11b/g WLAN's.

The 5-GHz band included the UNII-1, UNII-2, and UNII-3 bands, which had four channels each. The channels were spaced 20-MHz apart with an RF spectrum bandwidth of 20-MHz, for non-overlapping channels. There were differing restrictions for each related to transmit power, antenna gain, antenna styles, and usage. The UNII-1 band was designated for indoor use, and initially required permanently attached antennas. The UNII-2 band was designated for indoor/outdoor use, and permitted external antennas. The UNII-3 band was for outdoor bridge products that could be used for indoor/outdoor WLAN's, and it also permitted external antennas.

Portions of the 5-GHz band can be used by radar systems. DFS dynamically instructs a transmitter to listen and switch to a channel clear of radar signals. Prior to transmitting, the DFS listens for a radar signal that could be on that channel. If a radar signal is detected, the channel will be vacated and flagged as unavailable for use. The transceiver will continuously monitor the environment for the presence of radar, both prior to and during operation. This allows WLAN's to avoid interference with incumbent radar users in instances where they are collocated. Such features can simplify enterprise installations, because the devices themselves can automatically optimize their channel reuse patterns.

TPC technology allows the clients and access points to exchange information about their mutual signal levels. Each device dynamically adjusts its transmit power to uses only enough energy to maintain the communication at a given data rate. Adjacent cell interference is thus minimized, allowing for more densely deployed high-performance WLAN's. As a secondary benefit, client devices enjoy longer battery life because less power is used by the radio.

Briefly, a communications system embodiment of the present invention comprises a GSM subsystem capable of generating third harmonics whose frequency depends on which GSM channel is being used. A collocated WLAN subsystem uses OFDM subcarriers that can be interfered with by third harmonics of particular ones of the GSM channels. A calculator provides for a computation of which OFDM subcarriers would be adversely affected by a particular one of the GSM channels being in use. A subcarrier puncture device provides for the removal of an OFDM subcarrier between an FFT and a subcarrier demodulation mapping stage in the WLAN subsystem. The particular OFDM subcarrier to be removed is identified by the calculator.

An advantage of the present invention is a dual-mode handset is provided that is functional and reliable.

A further advantage of the present invention is a dual-mode handset is provided that can be implemented inexpensively.

A still further advantage of the present invention is that a method is provided that can be used for collocated GSM and 5-GHz WLAN devices.

The above and still further objects, features, and advantages of the present invention will become apparent upon consideration of the following detailed description of specific embodiments thereof, especially when taken in conjunction with the accompanying drawings.

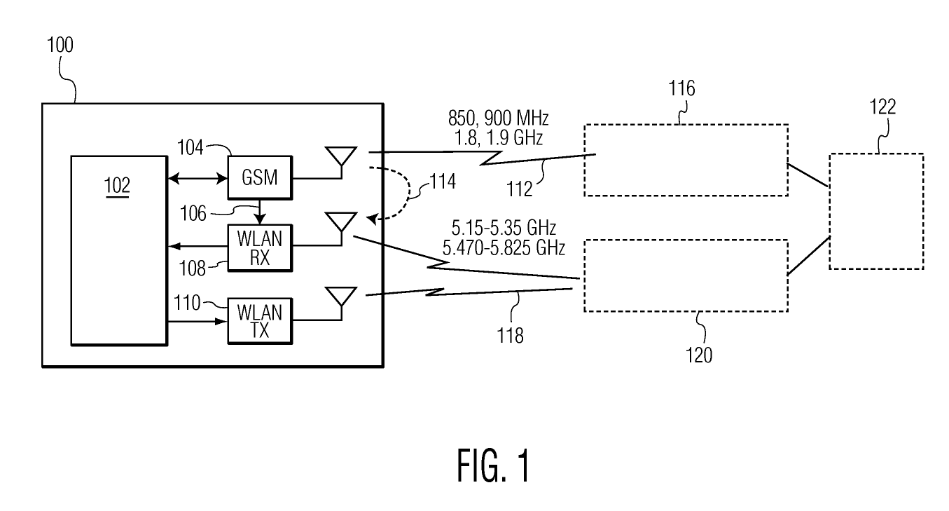

FIG. 1 is a functional block diagram of a dual-mode handset system embodiment of the present invention;

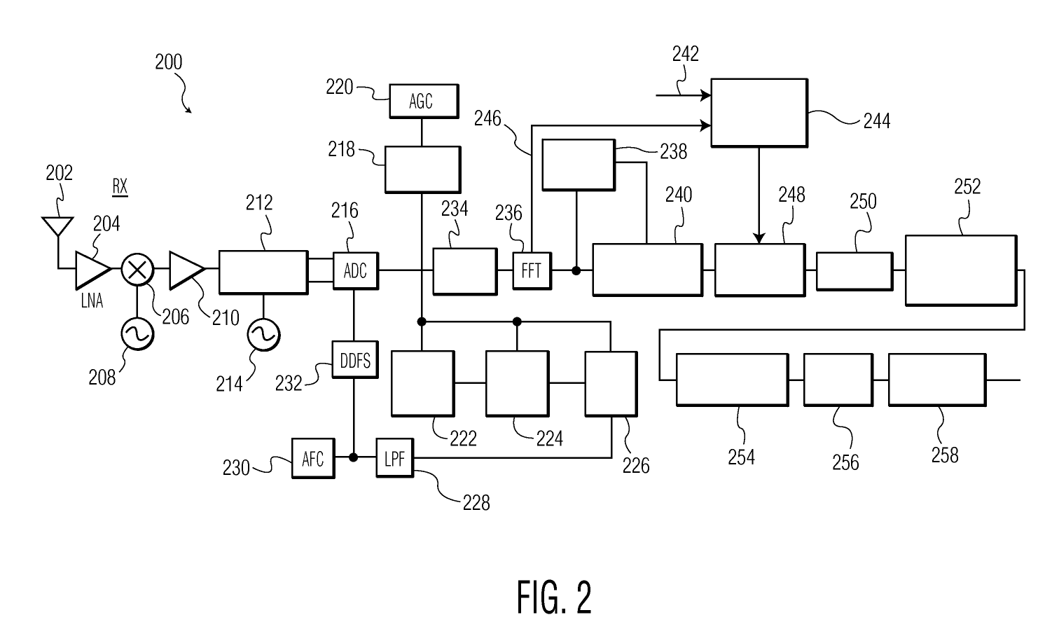

FIG. 2 is a functional block diagram of a WLAN receiver of the present invention; and

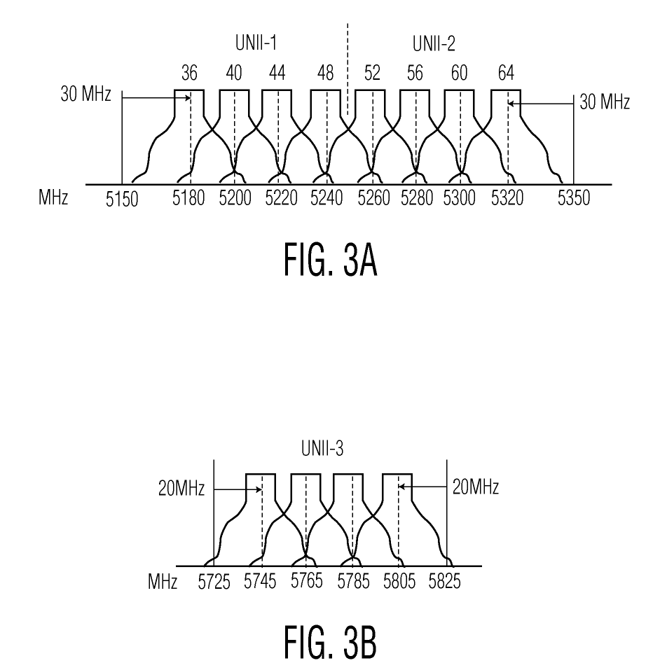

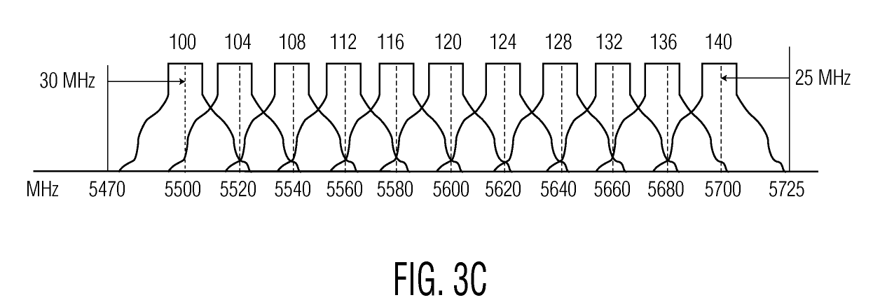

FIGS. 3A-3C are charts of the sub-carriers or channels defined for the 5-GHz UNII bands used by IEEE-802.11a WLAN's like those represented in FIGS. 1 and 2.

FIG. 1 represents a dual-mode handset system embodiment of the present invention, and is referred to herein by the general reference numeral 100. The dual-mode handset 100 comprises a phone 102, a GSM sub-system 104, a GSM channel information link 106, a WLAN receiver (RX) 108, and a WLAN transmitter (TX) 110. The GSM sub-system 104 conventionally communicates cellular phone conversations over a GSM link 112 on the 850, 900, 1800, and/or 1900-MHz radio bands. A spur, or third harmonic 114 in the 5-GHz spectrum spuriously couples back into the WLAN RX 108 and can interfere with WLAN reception. The GSM channel information link 106 provides data which allows the WLAN RX 108 to deal with such interference.

A cellular radio access network (RAN) 116 supports the GSM telephone calls. When in range, IEEE-802.11a communications 118 will be received from an unlicensed mobile access network (UMAN) 120. The UNII communications 118 operate in two bands, 5.15-5.35 GHz, and 5.470-5.825 GHz, e.g., by Federal Communications Commission (FCC) regulation. A core mobile network 122 is able to maintain telephone communications with the dual-mode handset 100 through either the RAN 116 or the UMAN 120, depending on the user's relative positioning and service subscription.

Various products are commercially available now that can be used to implement dual-mode handset 100. Philips Electronics markets an unlicensed mobile access (UMA) semiconductor reference design for mobile handset manufacturers to bring UMA-enabled phones to their customers. The UMA reference design provides for a mobile phone's access of GSM and GPRS mobile services through traditional cellular networks to be automatically switched over to VoIP/WLAN access points. This gives mobile phone customers added flexibility for advanced phone services as their phones detect the fastest and most cost-effective network without interruptions. If a phone is taken out of the WLAN range, it seamlessly switches back to the cellular network.

UMA technology provides access, e.g., to GSM and GPRS mobile services over unlicensed spectrum technologies, including Bluetooth and 802.11. UMA technology allows subscribers to roam and handover between cellular networks and public and private unlicensed wireless networks using dual-mode mobile handsets. The Philips Nexperia™ Cellular System Solution 6120 supports a wide variety of multimedia applications and includes a GSM/GPRS/EDGE mobile platform, an RF baseband transceiver, a power amplifier, a power management unit, and a battery charger. Kineto UMA Client Software in the Nexperia 6120 System Solution enables mobile phones to roam seamlessly between mobile networks and WLAN's. Philips 802.11g WLAN SiP allows mobile phone users to access voice, data and multimedia services through WLAN networks up to five times faster than current 802.11b products, without compromising the battery life of mobile phones.

The UMA specifications were created by Alcatel, AT&T Wireless, British Telecom, Cingular, Ericsson, Kineto Wireless, Motorola, Nokia, Nortel, O2, Research in Motion, Rogers Wireless, Siemens, Sony-Ericsson and T-Mobile US. The specifications are available for download at www.umatechnology.org. The UMA technology specification, known as TS 43.318 in the 3rd Generation Partnership Program (3GPP) standards body, was approved for inclusion into 3GPP Release 6.

Many conventional devices could be retrofitted with embodiments of the present invention to improve operation. For example, Calypso Wireless, Inc. markets a dual-mode, Wi-Fi/GSM-GPRS VoIP cellular phone, the C1250i, that runs on Intel PXA chipset. Calypso Wireless ASNAP technology is described in U.S. Pat. No. 6,680,923, and such is incorporated herein by reference. ASNAP enables mobile users to seamlessly switch between cellular networks, e.g., GSM or Code Division Multiple Access, and 802.11 type Wi-Fi wireless local area networks (WLAN). Calypso C1250i dual band WiFi-GSM-GPRS VoIP cellular phones are able to access Wi-Fi zones and the Internet at broadband speeds of up to 11,000 Kbps per second (11-Mbps) enabling broadband connectivity.

Referring again to FIG. 1, in one scenario, a mobile subscriber with a UMA-enabled, dual-mode handset 100 moves within range of an unlicensed wireless network 120 to which the handset is allowed to connect. Upon connecting, handset 100 logs into a UMA network controller (UNC) via UMAN 120. The handset can be authenticated and authorized to access GSM voice and GPRS data services via the unlicensed wireless network 120. If authorized, the subscriber's current location information stored in the core network is updated. All mobile voice and data traffic thereafter is routed to the handset via the UMAN 120 rather than the cellular RAN 116. When a UMA-enabled subscriber handset 100 moves outside the range of a particular UMAN 120, the UNC and handset facilitate roaming back to the licensed outdoor network, e.g., cellular RAN 116. Such roaming process is preferably seamless to the subscriber. If a subscriber is on an active GSM voice call, or GPRS data session when they cross within range of an unlicensed wireless network, the voice call or data session will automatically handover between access networks

The GSM radio frequency spectrum specified for GSM-900 System mobile radio networks uses one hundred twenty-four frequency channels with a bandwidth of 200-KHz for both the uplink and downlink direction. The mobile station to BTS uplink uses 890-MHz to 915-MHz, and the BTS to mobile station downlink uses 935-MHz to 960-MHz. The duplex spacing between the uplink and downlink channels is 45-MHz. The so-called E-GSM band adds fifty frequency channels and the R-GSM another twenty frequency channels to the spectrum.

In the frequency range specified for GSM-1800 System mobile radio networks, three hundred seventy-four frequency channels with a bandwidth of 200-KHz are available for both the uplink and downlink direction. The uplink uses the frequencies between 1710-MHz and 1785-MHz and the downlink uses the frequencies between 1805-MHz and 1880-MHz. The duplex spacing is 95-MHz. The third harmonics of several of these channels fall with the UNII channels set aside for IEEE-802.11a WLAN operation. It is therefore the job of link 106 to inform WLAN RX 108 which GSM channel is being used. If a calculation of the third harmonic reveals a potential interference problem with a WLAN OFDM sub-carrier, that particular sub-carrier is thereafter punctured (deleted). The error correction and detection mechanisms normal to receiver operation within the WLAN RX 108 will automatically restore the lost data bits carried by the punctured sub-carrier.

The GSM system uses time division multiple access (TDMA) in combination with frequency division multiple access (FDMA). Each radio channel is partitioned into eight timeslots, and each user is assigned a specific frequency-and-timeslot combination. Thus, only a single mobile uses a given frequency/timeslot combination in any particular session. Frequency division duplexing (FDD) provides two symmetric frequency bands, one for the uplink channels, and the other for downlink channels.

OFDM splits a high data-rate datastream into a many lower rate streams transmitted simultaneously over a number of subcarriers. The symbol duration increases for the lower rate parallel subcarriers, so the relative amount of dispersion in time caused by multipath delay spread is decreased. Inter-symbol interference (ISI) is eliminated almost completely because the OFDM allows adequate guard intervals between successive OFDM symbols.

FIG. 2 represents a WLAN RX embodiment of the present invention, and is referred to herein by the general reference numeral 200. The WLAN RX 200 is a familiar IEEE-802.11a OFDM receiver, and can be used in the dual mode handset 100. There are, however several improvements over conventional WLAN receivers. Such improvements may be retrofitted to conventional receivers to improve their performance in the case of collocated GSM devices that generate strong third harmonics.

The WLAN RX 200 comprises a receiving antenna 202 that feeds 5-GHz signals to a low-noise amplifier (LNA) 204. A mixer 206 and local oscillator 208 downconvert the RF for an automatic gain control (AGC) amplifier 210. The in-phase and quadrature-phase (I&Q) are separated in an IQ-separator 212 drive by a local oscillator 214. An analog to digital converter (ADC) converts for digital processing. A power detector 218 and AGC 220 compute power and set input gain. A coarse frequency synthesizer 222, symbol timing synthesizer 224, and fine frequency synthesizer 226 provide an automatic frequency control (AFC) feedback through a low pass filter (LPF) 228. AFC 230 guides direct digital frequency synthesis (DDFS) 232. A block 234 removes the guard interval (GI).

The output from an FFT block 236 is a sequence of complex numbers, each describing the signal received on one of the OFDM carriers. The numbers correspond to the values, chosen from the points of the current constellation, which were used to modulate each carrier at the modulator. However, each carrier is received with unknown amplitude and phase due to the combined effects of the channel through which the RF signal has passed, and any minor error in the FFT timing window.

The purpose of a pilot extraction 238 and a channel compensation block 240 is to correct these effects so that the complex numbers at its output would, if plotted on an Argand diagram, correspond to points of the transmitted constellation, except for any superimposed noise or interference. The transmitted DVB-T signal contains scattered pilots, which are distributed among the data cells in a regular pattern. These are transmitted with known values. The imaginary part is always zero, while the real part has a fixed amplitude. The sign of the real part, however, is determined by the carrier number. Each received scattered-pilot cell is compared with the known transmitted value to obtain a snapshot of the response of the channel for the corresponding carrier at that time instant. The data cells that must be corrected lie between the scattered pilots, in both frequency and time. This allows for appropriately generated corrections for each data cell by using a suitable form of interpolation applied to the measured values of the scattered pilots. As well as obtaining “in-between” values of the channel response, the interpolator also slightly reduces the effects of thermal noise on the scattered-pilot measurements. The reduction in noise and the fact that scattered pilots are transmitted with a power approximately 2.5 dB greater than data cells, keeps the inevitable loss of performance due to scattered-pilot noise within acceptable bounds.

A GSM channel information 242 provides a calculate spur block 244 with a priori data on which GSM channel is being used by a collocated GSM subsystem. The third harmonic of this GSM channel could coincide with a particular OFDM sub-carrier. If so, a signal is sent to a puncture sub-carrier block 248. The respective FFT output is deleted so that it cannot corrupt the overall demodulation of the received WLAN data.

If the GSM channel information 242 is not available for any reason, a prediction of GSM channel interference is provided in a symbol information 246 from FFT 236. The calculate spur block 244 computes which OFDM sub-carrier should be deleted in that instance.

The remaining data demodulation and recovery for the WLAN RX are conventional and include a forward error correcting sub-system to properly reconstruct the originally transmitted data. A equalizer 250 normalizes all the sub-carrier data for a subcarrier demodulation mapper 252. A data de-interleaver 254 recovers the serial datastream from the many parallel datastreams, a Viterbi decoder 256 removes noise errors, and a data descrambler 258 completes the demodulation.

Using multiple subcarriers also makes OFDM systems more robust in the presence of fading. Because fading typically decreases the received signal strength at particular frequencies, the problem affects only a few of the subcarriers at any given time. Error-correcting codes provide redundant information that enables OFDM receivers to restore the information lost in these few erroneous subcarriers.

Each of the subcarriers in an OFDM system can be modulated individually using whatever technique suits the application. In 802.11a, the choices include BPSK, QPSK, 16-QAM, and 64-QAM.

After modulation, the data from all the subcarriers are converted to a single stream of symbols for transmission. At the receiver, the stream is converted to the frequency domain via fast Fourier transform (FFT), then each “frequency bin” (subcarrier) is decoded separately.

FIGS. 3A-3C diagram the OFDM channel frequencies that are expected to be used by the WLAN receivers 108 and 200 in FIGS. 1 and 2. Regulatory action by various governments may change the details provided here, but the basic problem with third harmonics interfering with subcarriers used by collocated devices would nevertheless still apply.

A method embodiment of the present invention for reducing the third harmonic interference of collocated GSM transmitters in 5-GHz OFDM WLAN receivers comprises calculating the frequency location of a spur, and using the result of the calculation to delete a corresponding sub-carrier or bin output of an FFT block. The calculation can either use channel information passed directly from the interfering GSM transmitter, or it can be predicted from symbol information passed by the FFT block.

Although particular embodiments of the present invention have been described and illustrated, such is not intended to limit the invention. Modifications and changes will no doubt become apparent to those skilled in the art, and it is intended that the invention only be limited by the scope of the appended claims.

1. A communications system, comprising:
a subsystem capable of generating harmonics whose frequency depends on which GSM channel in a plurality of GSM channels is being used;
a WLAN subsystem with OFDM subcarriers that can be interfered with by third harmonics of particular ones of said plurality of GSM channels;
a calculator providing for a computation of which OFDM subcarriers would be adversely affected by a particular one of said plurality of GSM channels being in use; and
a subcarrier puncture device providing for the removal of an OFDM subcarrier between an FFT and a subcarrier demodulation mapping stage in the WLAN subsystem, wherein the particular OFDM subcarrier to be removed is identified by the calculator;
wherein, a forward error correcting sub-system may thereafter properly reconstruct an originally transmitted data.

2. The communications system of claim 1, further comprising:
a link between the GSM subsystem and the calculator providing for the identification of a particular one of said plurality of GSM channels that is being used.

3. The communications system of claim 1, further comprising:
a connection between said FFT and the calculator providing for the estimation of a particular one of said plurality of GSM channels that may be in use.

4. The communications system of claim 1, wherein the GSM and WLAN subsystems are collocated.

5. A method for improving data communication quality in collocated GSM and WLAN subsystems, wherein said GSM subsystem is capable of generating third harmonics whose frequency depends on which GSM channel in a plurality of GSM channels is being used, and wherein, said WLAN subsystem uses OFDM subcarriers that can be interfered with by third harmonics of particular ones of said plurality of GSM channels, the method comprising:
computing which OFDM subcarriers would be adversely affected by a particular one of said plurality of GSM channels being in use; and
removing a particular OFDM subcarrier at a point between an FFT and a subcarrier demodulation mapping stage in the WLAN subsystem, wherein the particular OFDM subcarrier to be removed is identified by the calculator.

6. A method for reducing the third harmonic interference of close-in GSM transmitters in 5-GHz OFDM WLAN receivers, comprising:
calculating the frequency location of a spur generated by a GSM radio transmission of a collocated GSM device; and
using a result of the calculation to delete a corresponding sub-carrier or bin output of an FFT block.

7. The method of claim 6, further comprising:
using channel information passed directly from an interfering collocated GSM transmitter as a parameter passed to the step of calculating; or
predicting from symbol information from an FFT block a likely GSM channel in use by nearby GSM transmitter, and passing a data to the step of calculating.

8. An apparatus for reducing the third harmonic interference of close-in GSM transmitters in 5-GHz OFDM WLAN receivers, comprising, and for calculating the frequency location of a spur generated by a GSM radio transmission of a collocated GSM device; and for using a result of the calculation to delete a corresponding sub-carrier or bin output of an FFT block, and for using channel information passed directly from an interfering collocated GSM transmitter as a parameter passed to the step of calculating, or predicting from symbol information from an FFT block a likely GSM channel in use by nearby GSM transmitter, and passing a data to the step of calculating, comprising:
a calculator providing for a computation of which OFDM subcarriers would be adversely affected by a particular one of said plurality of GSM channels being in use; and
a subcarrier puncture device providing for the removal of an OFDM subcarrier between an FFT and a subcarrier demodulation mapping stage in the WLAN subsystem, wherein the particular OFDM subcarrier to be removed is identified by the calculator.
